(19) United States
(12) Patent Application Publication
(10) Pub. No.: US 2025/0285253 A1
(43) Pub. Date: Sep. 11, 2025

(54) VIDEO QUALITY METRIC FOR FRAME INTERPOLATED CONTENT

(71) Applicants: Disney Enterprises, Inc., Burbank, CA (US); ETH Zürich (Eidgenössische Technische Hochschule Zürich), Zürich (CH)

(72) Inventors: Yang Zhang, Dübendorf (CH); Göksel Mert Çökmez, Zürich (CH); Tunc Ozan Aydin, Zürich (CH); Christopher Richard Schroers, Uster (CH)

(73) Assignees: Disney Enterprises, Inc., Burbank, CA (US); ETH Zürich (Eidgenössische Technische Hochschule Zürich), Zürich (CH)

(21) Appl. No.: 19/071,355

(22) Filed: Mar. 5, 2025

Related U.S. Application Data
(60) Provisional application No. 63/561,966, filed on Mar. 6, 2024.

(51) Int. Cl. G06T 7/00

(52) U.S. Cl. CPC G06T 7/0002; G06T 2207/10016; G06T 2207/20081; G06T 2207/30168

(57) ABSTRACT

In some embodiments, a method receives a first video. The first video includes frames that were generated using frame interpolation. A feature extractor extracts first features from frames of the first video. The first features are extracted from a plurality of levels of a network of the feature extractor. A spatio-temporal processing system analyzes the first features spatially and temporally to determine spatial and temporal features for the plurality of levels. The method combines the spatial and temporal features from the plurality of levels to determine a score that measures a quality of the first video.

### CROSS REFERENCE TO RELATED APPLICATIONS

Pursuant to 35 U.S.C. § 119 (c), this application is entitled to and claims the benefit of the filing date of U.S. Provisional App. No. 63/561,966 filed Mar. 6, 2024, entitled “VIDEO QUALITY METRIC FOR FRAME INTERPOLATED CONTENT”, the content of which is incorporated herein by reference in its entirety for all purposes.

### BACKGROUND

Video frame interpolation generates new frames from existing frames of a video. The new frames may be used to up sample the video frame rate. Video frame interpolation can introduce artifacts that degrade the perceived quality of the video. A system can attempt to assess the quality of the video using metrics that compare pixel values or low level visual patterns to perform the quality assessment, such as peak signal-to-noise ratio (PSNR) or structural similarity index measure (SSIM). However, assessing the quality of the video using these metrics may not properly evaluate the artifacts introduced by video frame interpolation. For example, the metrics are not specifically designed to recognize and evaluate the video frame interpolation artifacts, which may include temporal artifacts.

### BRIEF DESCRIPTION OF THE DRAWINGS

The included drawings are for illustrative purposes and serve only to provide examples of possible structures and operations for the disclosed inventive systems, apparatus, methods, and computer program products. These drawings in no way limit any changes in form and detail that may be made by one skilled in the art without departing from the spirit and scope of the disclosed implementations.

FIG. 1 depicts a simplified system for generating frame interpolation scores according to some embodiments.

FIG. 2 depicts and more detailed example of a frame interpolation score system according to some embodiments.

FIG. 3 depicts an example of training of a feature extractor according to some embodiments.

FIG. 4 depicts a more detailed example of the feature extractor according to some embodiments.

FIG. 5 depicts an example of the combination of features from different levels according to some embodiments.

FIG. 6 depicts a simplified flowchart of a method for generating frame interpolation scores according to some embodiments.

FIG. 7 illustrates one example of a computing device according to some embodiments.

### DETAILED DESCRIPTION

Described herein are techniques for a video analysis system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A system performs a frame interpolation assessment to generate a frame interpolation score that rates the quality of a video. The system is configured to detect video frame interpolation artifacts that may occur due to frame interpolation. For example, the system uses a feature extraction system to extract features at multiple levels of a feature extraction network that performs the feature extraction. The feature extraction system may have been trained to extract features based on how a human would perceive the features. This extracts features that provide a more accurate frame interpolation score that is in line with human perception. The system also includes a spatio-temporal network that processes the spatial and temporal features across the multiple levels of features by applying attention in three dimensions of height, width, and video frames. The output is a representation of the spatial and temporal features. The representation is processed to determine a frame interpolation score that evaluates video frame interpolation artifacts. The frame interpolation score may be in line with human perception of the artifacts.

### System

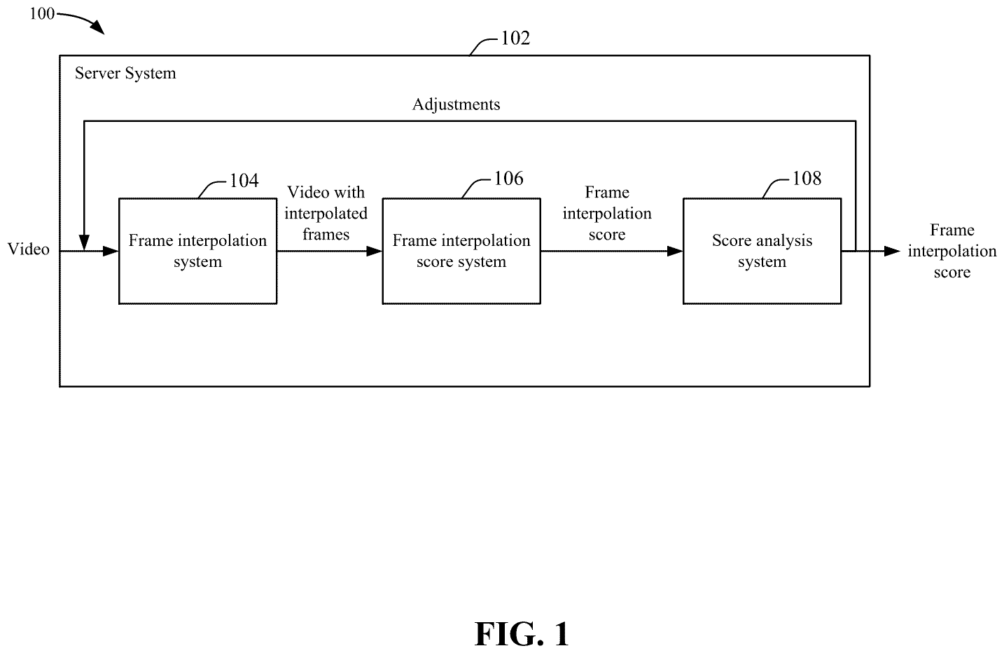

FIG. 1 depicts a simplified system 100 for generating frame interpolation scores according to some embodiments. A server system 102 includes a frame interpolation system 104, a frame interpolation score system 108, and a score analysis system 110. Components of server system 102 may be implemented on one or more computing devices. For example, the functions described may be distributed across multiple computing devices.

Frame interpolation system 104 receives content, such as a video. Frame interpolation system 104 may perform frame interpolation to generate new frames from the existing frames of the video. The new frames may be inserted between the existing frames, which may increase the frame rate of the video. The result may be a video that includes the existing frames and new frames.

Frame interpolation may involve analyzing the motion and content of adjacent frames to create the new frames that approximate the content of additional frames if the frame rate was higher. The interpolation process may result in frame interpolation artifacts. For example, distortion may result in some of the new frames. Frame interpolation may result in temporal artifacts, spatial artifacts, or spatio-temporal artifacts. Temporal artifacts may include artifacts based on motion or changes over time. Some examples of temporal artifacts include temporal aliasing, motion discontinuity, temporal jitter, etc. Spatial artifacts may be artifacts in a single frame, such as edge artifacts, texture artifacts, etc. Spatio-temporal artifacts may be artifacts based on temporal and spatial characteristics, such as motion blur, ghosting, interpolation errors, etc.

In some embodiments, the analysis may be based on a full reference process or no reference process. The full reference process may analyze a reference video and a distorted video, and determine a frame interpolation score based on the differences between frames in the videos. The distorted video may be a video with interpolated frames included. Also, the distorted video may only include distorted frames and not the original frames. Further, although frame interpolation is discussed, the process may be used to analyze any distorted video. The reference video may be a video without interpolated frames. The no reference process may analyze a distorted video without a reference video, and output a frame interpolation score based on the distorted video.

Frame interpolation score system 106 receives the distorted video, which include the new frames, and outputs a frame interpolation score (or scores). Frame interpolation score system 106 may analyze the video spatially and temporally to determine the frame interpolation score. In some embodiments, frame interpolation score system 106 may analyze groups of frames together (e.g., 12 frames), and determine a score for each group. The multiple scores may be output or combined into a single score for the video.

As will be discussed in more detail below, frame interpolation score system 106 uses a feature extractor and a spatio-temporal network. The feature extractor may extract features from the video. Each frame may be input into the frame extractor, and the frame extractor extracts features for the respective frame. The extracted features may be represented as a representation (e.g., embedding) in a space (e.g., embedding space). In some embodiments, the feature extractor may include an image encoder that extracts the features from the frame. As will be discussed in more detail below, the image encoder may have been trained with a text encoder to extract features based on text that is encoded by the text encoder. This type of training may extract features that may be in line with features that would be perceived by users.

The feature extractor may extract features from multiple levels of the network of the feature extractor. For example, multiple levels of the network that is extracting features may be modified to output features. This results in multiple levels of features. The multiple levels of features may be analyzed temporally and spatially. Previously, only one level of features may have been output and analyzed. The multiple levels of features provide different insights into characteristics of the video. For example, lower levels may provide information on edges, lines, textures; mid-levels may provide information on objects, shapes, and higher levels may provide semantic information such as scenes, concepts, etc. As the levels increase, more semantic information is provided in the features.

The spatio-temporal network may analyze the features spatially and temporally. For example, the multiple levels of features that were extracted may be respectively analyzed spatially and temporally. The spatio-temporal network may apply attention in a window across three dimensions, which may be height, width, and video frames. The video frames dimension may be a temporal dimension because features from multiple video frames over time are analyzed. This applies attention spatially and temporally to the features. More important spatial or temporal features are given more attention and less important spatial or temporal features are given less attention. The spatio-temporal network may output a representation (e.g., a latent representation) for the spatial and temporal features for the window. The window is slid across different portions of three dimensions for the frames to generate a representation for the frames. This process is performed for all levels. Then, the representations from the multiple levels may be combined. The frame interpolation score may be determined from the combination.

Score analysis system 108 receives the frame interpolation score and analyzes the frame interpolation score to determine any actions to perform. Score analysis system 108 may determine adjustments to the frame interpolation system based on the frame interpolation score. For example, a low frame interpolation score may mean that the frame interpolation process may need to be changed. In this case, different settings for frame interpolation may be used to interpolate frames to generate a new video. Also, on the client side, the no reference analysis may be used since there may not be a reference video. For example, after streaming the video to the client, the quality of the video may be analyzed. If a low frame interpolation score is determined, then the streaming of the video to the client may need to be adjusted.

Also, score analysis system 108 may output the frame interpolation scores for further analysis. A user may review the frame interpolation score and determine any actions to perform.

The following will describe frame interpolation score system 106 in more detail.

### Frame Interpolation Score System

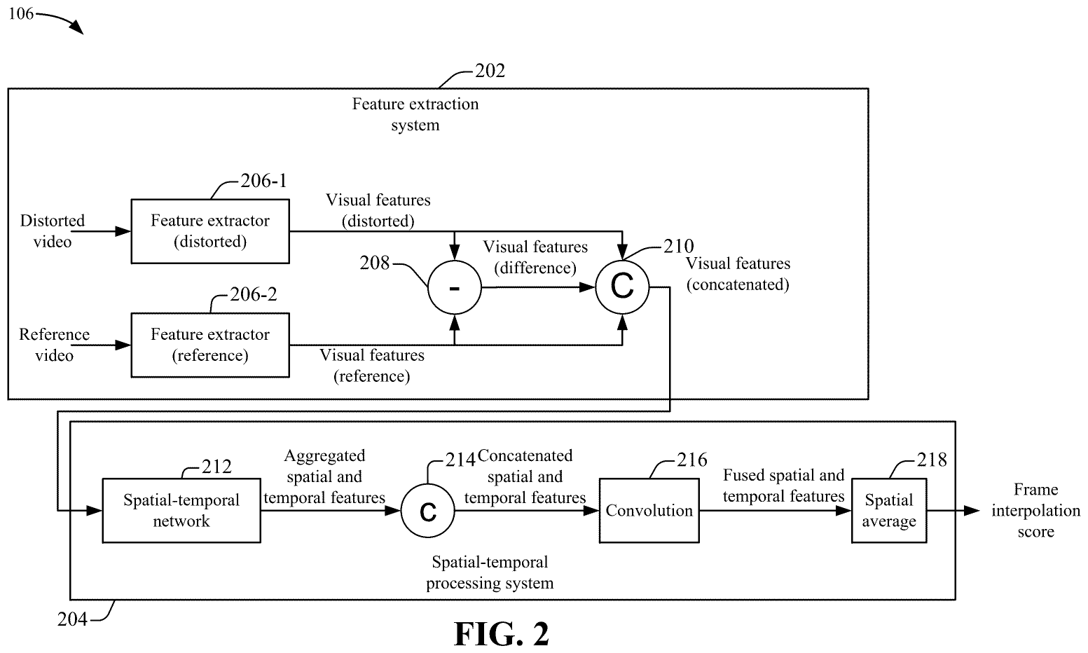

FIG. 2 depicts a more detailed example of frame interpolation score system 106 according to some embodiments. Frame interpolation score system 106 includes a feature extraction system 202 and a spatio-temporal processing system 204.

Frame interpolation score system 106 may operate as a full reference process or zero reference process. The full reference system is described in FIG. 2. The full reference system may analyze a reference video and a distorted video. The frame interpolation score may analyze the differences between the reference video and the distorted video. If the no reference system is used, then the reference video is not input. Rather, only the features of the distorted video are analyzed in the no reference system. The frame interpolation score may measure the quality of the distorted video only in the no reference process. In this case, the difference operation at 208 and concatenation at 210 may also be removed, and only the features of the distorted video are input into spatio-temporal processing system 204.

In feature extraction system 202, a feature extractor 206-1 receives frames from a distorted video. Also, a feature extractor 206-2 receives frames from a reference video. The distorted video may be a video in which frame interpolation is performed. The interpolated frames may have artifacts. The reference video may be a video in which frame interpolation is not performed. In some embodiments, feature extractor 206 may analyze a group of frames at once. For example, 12 frames may be analyzed at once. The frame interpolation score may be output for these 12 frames. In some embodiments, frames 1-12 may be analyzed, then frames 13-24, etc. Also, a sliding window may be where frames 1-12 are analyzed, then frames 2-13, frames 3-14, etc.

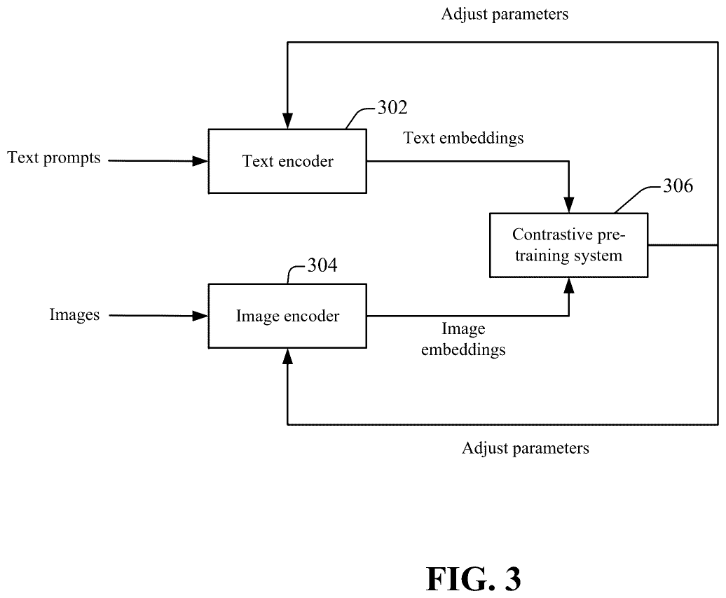

Feature extractor 206-1 extracts visual features (distorted) from the distorted video. Similarly, feature extractor 206-2 extracts visual features (reference) from the reference video. Different feature extractors may be used. In some embodiments, a feature extractor that is trained using a text encoder may be used. As will be described below, the visual features may be extracted at multiple levels (e.g., at multiple levels of the network of feature extractor 206). An example of this system is described in FIG. 3.

In some embodiments, the same feature extractor is used although two instances are shown. Feature extractor 206 extracts features from 12 consecutive frames by inputting each frame individually into feature extractor 206, as expressed in Eq. (1):

$${F}_{\{ ref - dist \}} = {f}_{CLIP , l} ( {I}_{\{ ref - dist \}} ) , \qquad ( 1 )$$

where features F_{ref,1} and F_{dist,1} indicate the extracted reference and distorted video features from the corresponding level 1 of feature extractor 206. Features F_{ref,1} and F_{dist,1} may be representations, such as embeddings that are in an embedding space. The features may be extracted for multiple channels, which may be different characteristics (e.g., edges, colors, etc.). I_{ref} and I_{dist} denote the reference and distorted videos, respectively. f_{CLIP,I}(⋅) refers to the operation at the corresponding level 1 of feature extractor 206, which is a mapping in the form:

$${f}_{CLIP , l} = {ℝ}^{B \times 12 \times 3 \times 224 \times 224} \to {ℝ}^{B \times 12 \times i \times j \times j} ,$$

where B denotes the input batch size, i∈[1024, 1024, 512, 256, 64], and j∈[7, 14, 28, 56, 112]. The number 12 is the number of frames, i is the number of channels in a corresponding layer of feature extractor 206, j is the spatial size in height or width. For this example, the values for the levels are: Level 5: i=1024, j=7; Level 4: i=1024, j=14; Level 3: i=512, j=28; Level 2: i=256, j=56; and Level 1: i=64, j=112. This process is repeated for both the distorted frames and reference frames.

At 208, the visual features (distorted) and the visual features (reference) may be combined to determine visual features (difference). For example, the difference between the visual features (distorted) and the visual features (reference) is determined. Now, three sets of visual features have been determined of visual features (distorted), visual features (reference), and visual features (difference). At 210, the three sets of visual features may be combined, such as concatenated into concatenated visual features. Each set of visual features may be represented by the tensor with the shape [12, i, j, j].

After extracting the features from the distorted and reference frames, feature extraction system 202 fuses the distorted frame features F_{dist,1} and the reference frames features F_{dist,1} accordingly in each level. First, feature extraction system 202 normalizes the extracted features F_{dist,1} and F_{ref,1} across frames to further highlight temporal features. Then, feature extraction system 202 computes the element-wise absolute difference F_{diff,1} between the reference and distorted frames features. This can be represented as the following in Eq. (2):

$${F}_{diff , l} = abs ( {f}_{norm} ( {f}_{norm} ( {F}_{ref , l} ) - {f}_{norm} ( {F}_{dist , l} ) ) , . \qquad ( 2 )$$

In Eq. (2), F_{ref,l} and F_{dist,l} represent the features extracted from the reference and distorted videos, respectively. fₙₒᵣₘ(⋅) is the normalization operation across frames, abs(⋅) is the element-wise absolute difference operator, and F_{diff,l} is the element-wise absolute difference of the normalized reference and distorted features.

The resulting difference tensor is then concatenated with the reference features F_{ref,l} and the distorted features F_{dist,l} in the channel dimension. These operations can be represented as:

$${F}_{cat , {l}^{=}} {f}_{cat} ( {f}_{norm} ( {f}_{norm} ( {F}_{ref , l} ) , {f}_{diff , l} , {f}_{norm} ( {F}_{dist , l} ) ) , \qquad ( 3 )$$

where f_{cat(⋅)} represents the concatenation operation for the extracted features along the channel dimension, resulting in a shape of a tensor [symbol] ^{B×12×3i×j×j}. Here, the term “3i” represents the three features of visual features (distorted), the visual features (reference), and the visual features (difference). That is, 3i is 3 times i, as every feature set (reference, distorted, their difference) has the same number of channels. Thus, when they are concatenated in the channel dimension, it essentially triples the number of channels. Note that these operations are repeated for every level of feature extractor 206. The extracted features are input into spatio-temporal processing system 204 to calculate spatial and temporal features.

At 212, a spatio-temporal network 212 analyzes the concatenated visual features spatially and temporally to generate aggregated spatial and temporal features. Spatio-temporal network 212 may be a transformer. Each level of the extracted features may be processed by spatio-temporal network 212. In some embodiments, spatio-temporal network 212 computes attention inside sliding windows across three dimensions that include height, width, and video frames. The dimension of video frames may capture temporal features between frames. This is different from sliding windows that are only applied across the height and width of a frame, which does not capture temporal features. Using a sliding window that applies attention across the temporal dimension, spatial and temporal features are represented in the latent representation of the window. Spatio-temporal network 212 may apply self-attention to weight features higher that are more important and weight features lower that are less important. This outputs a representation for the window that captures the spatial and temporal features. The output of spatio-temporal network 212 is a latent representation of the spatial and temporal features. This is performed at every level. The method of computing attention across multiple frames ensures that temporal features are also represented in the latent features in addition to the spatial features. This operation is denoted as:

$${F}_{spte , l} = {f}_{spte , l} ( {F}_{cat , l} ) , \qquad ( 4 )$$

where, f_{spte,l}(⋅) represents the operation of spatio-temporal network 212 on concatenated features F_{cat,l} on every level l. The output features from individual levels of spatio-temporal network 212 have the shape of a tensor [symbol] ^{B×12×32×j×j}. The term “32” means the number of output channels of spatio-temporal network 212, but other numbers of channels may be used. In each level, the number of input channels to spatio-temporal network 212 may be different, but the output dimension may remain the same. Also, same as before, j is the height=width of the input tensor, so it is [7, 14, 28, 56, 112] depending on the level of the network. Note that the number of channels for each level is now 3i. The inputs and outputs are: Level 5: 12×3072×7×7->Output->12×32×7×7; Level 4: 12×3072×14×14->Output->12×32×14×14; Level 3: 12×1536×28×28->Output->12×32×28×28; Level 2: 12×768×56×56->Output->12×32×56×56; and Level 1: 12×192×112×112->Output->12×32×112×112.

The aggregated temporal features are then concatenated at 214 in the channel dimensions. This results in concatenated spatial and temporal features. A convolution network 216 analyzes the concatenated spatial and temporal features to fuse the features from all channels to a singular channel. This result in fused spatial and temporal features. This merges the spatial and temporal features. For example, the output features are concatenated in the channel dimensions and passed through a 1×1 convolution layer, which fuses features from all channels to a singular channel. This is repeated at every level and can be represented as the following in Eq. (5):

$${F}_{final , l} = {f}_{emb , l} ( {f}_{reshapel} ( {F}_{spte , l} ) ) , \qquad ( 5 )$$

where, f_{emb,l}(⋅) represents the 1×1 convolution operation to reduce the number of channels and fᵣₑₛₕₐₚₑ(⋅) represents the reshaping operation to shape [symbol] ^{B×384×j×j}, which merges the frame and channel dimensions of the tensor, effectively merging the spatial and temporal features. The aggregated temporal features of each frame is concatenated in the channel dimension. There are 12 frames with 32 channels each, which are merged to new dimensions in a new channel, which is 12×32-384 as the new number of channels. The dimensions are: Level 5: 384×7×7; Level 4: 384×14×14; Level 3: 384×28×28; Level 2: 384×56×56; and Level 1: 384×112×112.

At 208, the frame interpolation score is calculated by combining the feature representations, such as by using a spatial average. For example, the average of the features from all levels may be combined to determine the frame interpolation score. For example, the final frame interpolation score is calculated by adding the average of the features of shape [symbol] ^{B×j×j} from all levels as shown in Eq. (6):

$$dmos = {\sum }_{l = 0}^{L} \frac{1}{N} {\sum }_{m , n = 0}^{N} {F}_{final , l}^{( m , n )} , \qquad ( 6 )$$

where, dmos is the frame interpolation score, m and n denote the row and column indices for entries of the final features, F_{final},l in each level l. N represents the total number of entries at the level l of the tensor F_{final,l}. Other methods of determining the frame in interpolation score may be appreciated. The outputted frame interpolation score measures the difference between the distorted video and the reference video.

In the no reference process, feature extractor 206 extracts the features from the distorted video uniquely and the features are sent to spatio-temporal processing system 204 for spatial and temporal feature computation. The lack of reference video means that it is not possible to compute the element-wise difference between the reference and distorted video features. As a result, instead of calculating the difference between the reference and distorted videos and concatenating the resulting features in the channel dimension, this step is completely bypassed. Distorted video features coming from feature extractor 206 are fed directly into spatio-temporal network 212 for spatio-temporal attention computation. The remaining steps for combining features across frames and computing the frame interpolation scores with features from all levels remain identical to the full reference process.

The following will now describe different components of frame interpolation score system 106 in more detail.

### Feature Extraction System

FIG. 3 depicts an example of training of feature extractor 206 according to some embodiments. A text encoder 302 and an image encoder 304 may be trained together using a training method, such as contrastive learning. Text encoder 302 may receive text prompts that describe an image. For example, the text prompt may be “Hero the dog”, which may be a prompt about a dog. Image encoder 304 may receive corresponding images associated with the text prompts, such as images of a dog.

Text encoder 302 generates text embeddings for the text prompts. Imaging encoder 304 generates image embeddings for the images. The embeddings are created in an embedding space.

A contrastive pre-training system 306 receives the text embeddings and the image embeddings, and trains text encoder 302 and image encoder 304. In contrastive learning, contrastive pre-training system 306 trains parameters of text encoder 302 and image encoder 304 to distinguish between positive pairs and negative pairs. Positive pairs may be where the text prompt is similar to the image, and a negative pair is where the text prompt is dissimilar to the image. Contrastive pre-training system 306 adjusts parameters of text encoder 302 and image encoder 304 to learn to generate pairs that are positive closer in the embedding space and negative pairs farther apart in the embedding space.

The use of text encoder 302 and image encoder 304 together in the training process trains image encoder 304 based on human perception. Image encoder 304 is trained to extract features based on human perception. Image encoder 304 trained across a vast dataset alongside a text encoder. As text encoders are supposed to work well with different languages, they are good at capturing abstract things such as sentiment and meaning in a given text. Intuitively, this capability is reflected in its counterpart during training, which is image encoder 304. This image encoder 304 is trained to extract features in such a way that it is “compatible” or “in line” with the features of text encoder 302, which is good at guessing the semantic meaning and sentiment. Thus, image encoder 304 is good at catching features that may affect human quality perception.

After training, text encoder 302 and image encoder 304, image encoder 304 may be extracted and used as feature extractor 206. In some embodiment, the weights that were determined during training may be frozen in feature extractor 206, and the weights are used to extract features. In other embodiments, fine tuning of the weights may be performed.

### Feature Extractor

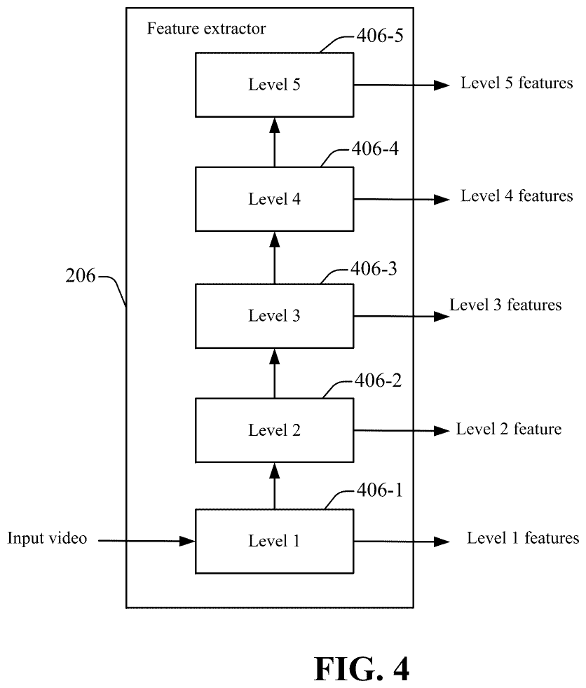

FIG. 4 depicts a more detailed example of feature extractor 206 according to some embodiments. As mentioned above, feature extractor 206 may extract multiple levels of features. Feature extractor 206 may have multiple levels of layers that perform different analysis on features. For example, each level may have one or more respective components of a network, such as convolutional layers. Each level may measure a different aspect of the features. For example, level 1 may analyze pixel level features, such as edges and textures. As the levels go up, the features that are extracted are more semantic. For example, level 5 may analyze high-level semantic information. The high-level semantic information may be features that describe the content, such as the image includes a dog. For example, the lower levels may analyze features such as edges and textures, the middle layers may measure objects or parts of the images, and the higher level levels may measure semantic information, such as scenes and activities. In some embodiments, as levels go from level 1 to level 5, the spatial dimensions of the convolution layers decrease. Regarding the features of each level, the features get more abstract and high level as the levels increase. The layer can detect edges and may be textures in Level 1, but as higher levels are reached, the features will represent higher level features, such as what is the object in the image, and maybe the material and the surrounding context to the object. Thus, the higher the level, the higher level features are output.

Feature extractor 206 receives input video at a level 1 406-1. Level 1 406-1 may extract level 1 features. An output from level 1 is included in feature extractor 206 to output level 1 features. Also, the level 1 features are input into level 2 406-2. Level 2 406-2 extracts level 2 features. Here, another output to output level 2 features is provided. Also, the level 2 features are input into level 3 406-3. This process continues as level 3 features, level 4 features, and level 5 features are extracted from the input video and output. Each of the level features may include different characteristics.

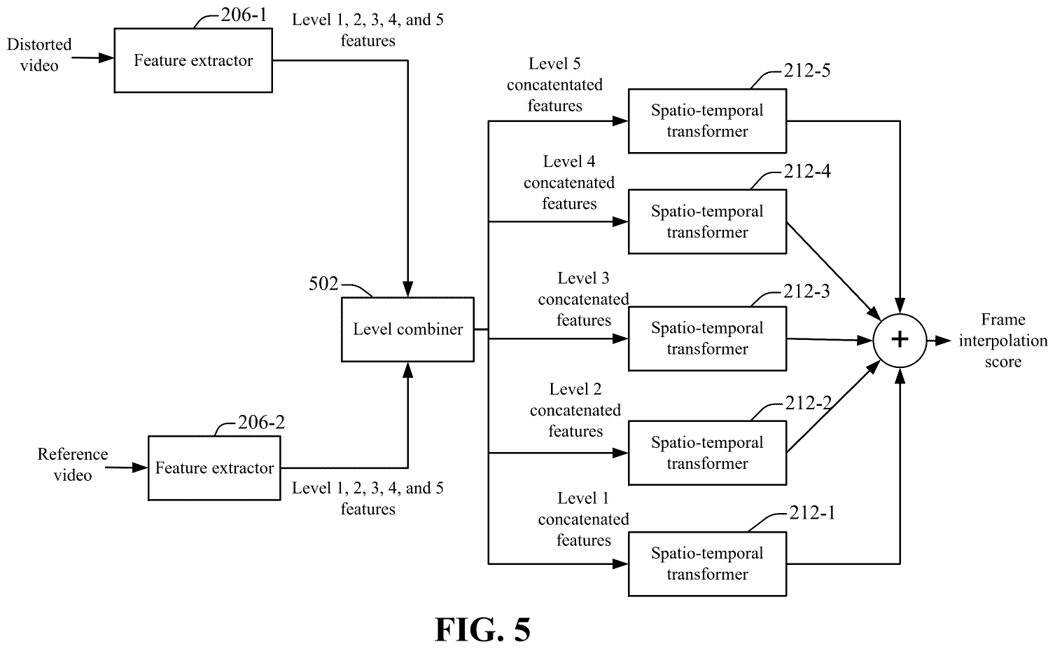

The multiple levels may be combined. FIG. 5 depicts an example of the combination of features from different levels according to some embodiments. Feature extractor 206-1 receives distorted video and feature extractor 206-2 receives a reference video. Feature extractor 206-1 and feature extractor 206-2 respectively output level 1, 2, 3, 4, and 5 features.

A level combiner 502 combines the level 1, 2, 3, 4, and 5 features from a group of frames into level 1 concatenated features, level 2 concatenated features, level 3 concatenated features, level 4 concatenated features, and level 5 concatenated features. Each of the concatenated features may be input into a spatio-temporal network 212. For example, respective level concatenated features are input into spatio-temporal network 212-1 to 212-5. The output of spatio-temporal network 212-1 to 212-5 are combined into a frame interpolation score. The logic to combine the levels is described above in FIG. 2.

### Score Generation

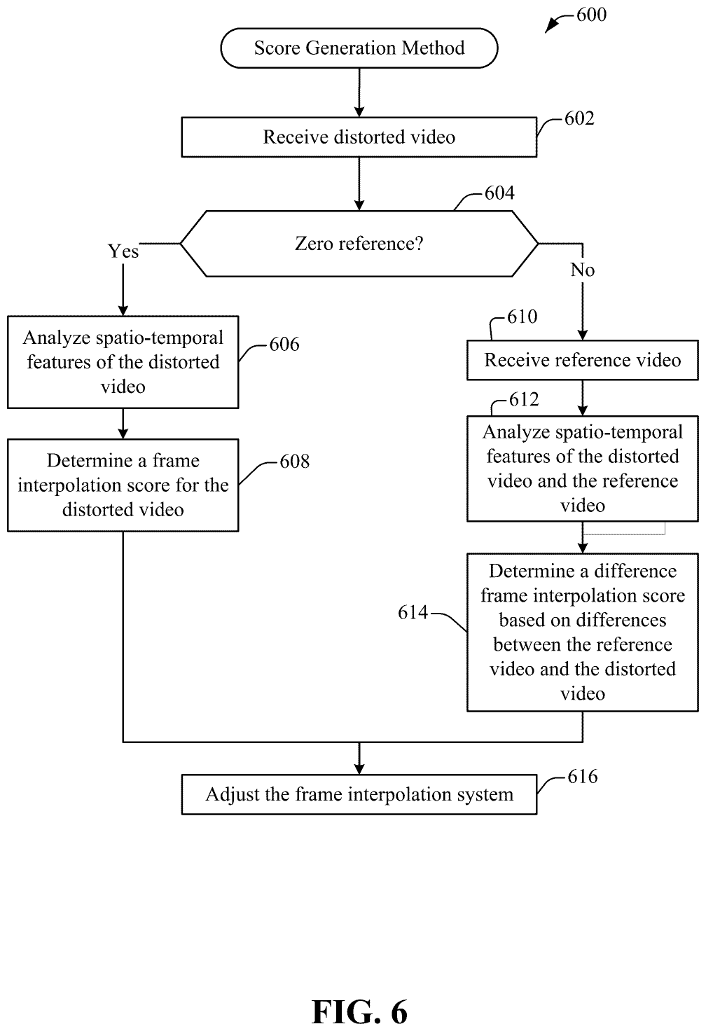

FIG. 6 depicts a simplified flowchart 600 of a method for generating frame interpolation scores according to some embodiments. At 602, frame interpolation system 106 receives distorted video. As mentioned above, a full reference or a zero reference process may be performed. At 604, frame interpolation system 106 determines if a zero reference process is being performed.

If a zero reference process is being performed, at 606, frame interpolation system 106 analyzes spatio-temporal features of the distorted video. The analysis may be performed as described above.

At 608, frame interpolation score system 106 determined a frame interpolation score for the distorted video. The frame interpolation score may be in different format. For example, a single score for the entire distorted video may be output. Also, scores for groups of frames, such as for the group of 12 frames, may be output. A single score may be generated by combining the multiple scores from the groups of frames that are analyzed.

If a full reference process is being performed, at 612, frame interpolation score system 106 receives a reference video. Then, at 614, frame interpolation score system 106 analyzes the spatial and temporal features of the distorted video and the reference video. At 616, frame interpolation score system 106 determines a difference frame interpolation score based on differences between the reference video and the distorted video. The difference frame interpolation score may be for the single for the whole video or for portions of the video.

At 618, score analysis system 108 may adjust the frame interpolation system or any other system based on the frame interpolation score or scores.

### Conclusion

Accordingly, a frame interpolation score that analyzes spatial and temporal artifacts from frame interpolation is output. This provides a more accurate frame interpolation score because temporal artifacts, which may result during frame interpolation, is captured in the analysis. This provides a more accurate score and allows optimal adjustments to be made to the frame interpolation system or other systems.

### System

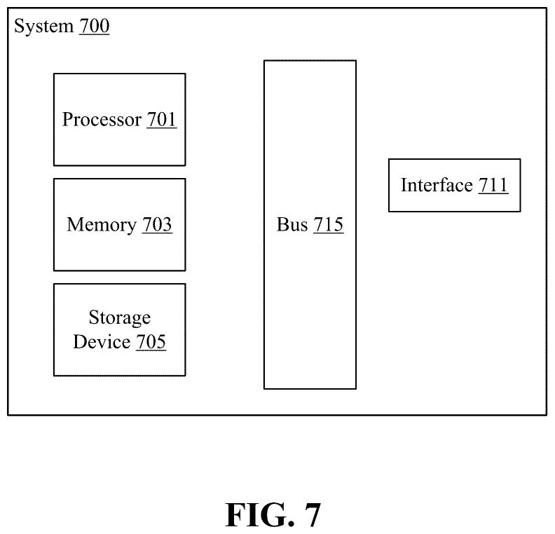

FIG. 7 illustrates one example of a computing device according to some embodiments. According to various embodiments, a system 700 suitable for implementing embodiments described herein includes a processor 701, a memory 703, a storage device 705, an interface 711, and a bus 715 (e.g., a PCI bus or other interconnection fabric.) System 700 may operate as a variety of devices such as server system 102, or any other device or service described herein. Although a particular configuration is described, a variety of alternative configurations are possible. Processor 701 may perform operations such as those described herein. Instructions for performing such operations may be embodied in memory 703, on one or more non-transitory computer readable media, or on some other storage device. Various specially configured devices can also be used in place of or in addition to processor 701. Memory 703 may be random access memory (RAM) or other dynamic storage devices. Storage device 705 may include a non-transitory computer-readable storage medium holding information, instructions, or some combination thereof, for example instructions that when executed by the processor 701, cause processor 701 to be configured or operable to perform one or more operations of a method as described herein. Bus 715 or other communication components may support communication of information within system 700. The interface 711 may be connected to bus 715 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
receiving a first video, wherein the first video includes frames that were generated using frame interpolation;
extracting, using a feature extractor, first features from frames of the first video, wherein first features are extracted from a plurality of levels of a network of the feature extractor;
analyzing, using a spatio-temporal processing system, the first features spatially and temporally to determine spatial and temporal features for the plurality of levels; and
combining the spatial and temporal features from the plurality of levels to determine a score that measures a quality of the first video.

2. The method of claim 1, further comprising:
receiving a second video, wherein the second video does not include frames that were generated using frame interpolation, wherein the second video is used to determine the score, and wherein the score is based on a difference between the first video and the second video.

3. The method of claim 2, further comprising:
extracting, using the feature extractor, second features from frames of the second video, wherein the second features are extracted from the plurality of levels of the network of the feature extractor;
combining the second features with the first features to determine concatenated features;
analyzing the concatenated features spatially and temporally to determine the spatial and temporal features for the plurality of levels; and
combining the spatial and temporal features from the plurality of levels to determine the score that measures the quality of the first video.

4. The method of claim 3, wherein combining the second features with the first features to determine concatenated features comprises:
determining a difference between the first features and the second features as difference features; and
combining the first features, the second features, and the difference features to determine the concatenated features.

5. The method of claim 1, wherein:
the feature extractor includes a network of a plurality of layers, and
a level in the plurality of levels receive features from a layer in the plurality of layers.

6. The method of claim 5, wherein layers in the plurality of layers analyze different characteristics of the first video.

7. The method of claim 1, wherein:
the feature extractor is trained using a text encoder, and
training is performed to adjust parameters of the feature extractor and the text encoder based on a first input of text to the text encoder and a second input of an image to the feature extractor.

8. The method of claim 7, wherein:
for a positive pair of the first input and the second input, the parameters of the feature extractor and the text encoder are adjusted such that embeddings generated by the feature extractor and the text encoder are closer together in an embedding space, and
for a negative pair of the first input and the second input, the parameters of the feature extractor and the text encoder are adjusted such that embeddings generated by the feature extractor and the text encoder are farther apart in the embedding space.

9. The method of claim 1, wherein analyzing the first features spatially and temporally comprises:
analyzing a window of features that includes dimensions of height, width, and frames to determine the spatial and temporal features.

10. The method of claim 9, wherein the spatio-temporal processing system applies attention to the spatial and temporal features in the window to weight features with more weight that are more important and weight features with less weight that are less important.

11. The method of claim 1, further comprising:
concatenating the spatial and temporal features in channel dimensions to determine concatenated spatial and temporal features; and
fusing the concatenated spatial and temporal features from all the channel dimensions into a single channel to determine fused concatenated spatial and temporal features.

12. The method of claim 11, wherein fusing the concatenated spatial and temporal features comprises:
using a convolution to fuse the concatenated spatial and temporal features into the single channel to determine fused concatenated spatial and temporal features.

13. The method of claim 12, further comprising:
combining the fused concatenated spatial and temporal features from the plurality of levels to determine the score.

14. The method of claim 13, wherein combining the fused spatial and temporal features comprises:
averaging the fused concatenated spatial and temporal features from the plurality of levels.

15. A non-transitory computer-readable storage medium having stored thereon computer executable instructions, which when executed by a computing device, cause the computing device to be operable for:
receiving a first video, wherein the first video includes frames that were generated using frame interpolation;
extracting, using a feature extractor, first features from frames of the first video, wherein first features are extracted from a plurality of levels of a network of the feature extractor;
analyzing, using a spatio-temporal processing system, the first features spatially and temporally to determine spatial and temporal features for the plurality of levels; and
combining the spatial and temporal features from the plurality of levels to determine a score that measures a quality of the first video.

16. A method comprising:
receiving a first video, wherein the first video includes frames that were generated using frame interpolation;
receiving a second video, wherein the second video does not include frames that were generated using frame interpolation;
extracting, using a feature extractor, first features from frames of the first video and second features from frames of the second video, wherein the first features and the second features are extracted from the plurality of levels of the network of the feature extractor;
combining the second features with the first features to determine concatenated features;
analyzing the concatenated features spatially and temporally to determine spatial and temporal concatenated features for the plurality of levels; and
combining the spatial and temporal concatenated features from the plurality of levels to determine a score that measures a quality of the first video.

17. The method of claim 16, wherein combining the second features with the first features to determine concatenated features comprises:
determining a difference between the first features and the second features as difference features; and
combining the first features, the second features, and the difference features to determine the concatenated features.

18. The method of claim 16, wherein analyzing the concatenated features spatially and temporally comprises:
analyzing a window of features that includes dimensions of height, width, and frames to determine the spatial and temporal concatenated features.

19. The method of claim 16, wherein:
the feature extractor is trained using a text encoder, and
training is performed to adjust parameters of the feature extractor and the text encoder based on a first input of text to the text encoder and a second input of an image to the feature extractor.

20. The method of claim 16, wherein analyzing the concatenated features spatially and temporally comprises:
analyzing a window of features that includes dimensions of height, width, and frames to determine the spatial and temporal concatenated features.
